(19) United States
(12) Patent Application Publication
(10) Pub. No.: US 2006/0140104 A1
(43) Pub. Date: Jun. 29, 2006

(54) Optical pickup and optical disk apparatus

(75) Inventors: Kenji Yamamoto, Kanagawa (JP); Noriaki Nishi, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SONY CORPORATION, Shinagawa-ku (JP)

(21) Appl. No.: 11/288,076

(22) Filed: Nov. 29, 2005

(30) Foreign Application Priority Data
Dec. 6, 2004 (JP) 2004-352950

(51) Int. Cl. G11B 7/00; G11B 7/135

(52) U.S. Cl. 369/112.23

(57) ABSTRACT

An optical pickup adapted to operate for optical disks of a plurality of different types and an optical disk apparatus include a light source for emitting a first light beam with a wavelength matching a first optical disk or a second light beam with a wavelength matching a second optical disk, an objective lens for converging the first light beam or the second light beam emitted from the light source onto the recording surface of the first optical disk or the second optical disk, whichever appropriate, and a first aberration correcting means arranged on the light path of the first light beam between the light source and the objective lens to generate an aberration for canceling the coma arising due to the objective lens.

### CROSS REFERENCES TO RELATED APPLICATIONS

The present invention contains subject matter related to Japanese Patent Application JP2004-352950 filed in the Japanese Patent Office on Dec. 6, 2004, the entire contents of which being incorporated herein by reference.

### BACKGROUND OF THE INVENTION

1. Field of the Invention

The present invention relates to an optical pickup and an optical disk apparatus, which may advantageously be mounted with an optical pickup that can record information onto and reproduce information from any of a plurality of optical disks of different types.

2. Description of the Related Art

FIG. 1 is an optical pickup mounted on a known optical disk apparatus that utilizes a 3-beam method as tracking control method in related art.

As clearly shown in FIG. 1, the optical pickup 101 divides the light beam L100 emitted from a laser diode 102 into a main beam and two side beams (to be referred to collectively as light beam L200 hereinafter) by means of a grating 103 in a replay mode. A part of the light beam L200 is transmitted through a beam splitter 104 to enter a photodetector 106 for detecting the quantity of emitted light while the remaining part of the light beam L200 is reflected by the beam splitter 104 to enter a collimator lens 105.

The collimator lens 105 transforms the incident light beam L200 into a collimated light beam, which is then made to irradiate a ¼ wave plate 108 by way of an upturn mirror 107. The ¼ wave plate 108 by turn transforms the incident light beam L200 into circularly polarized light. Then, the light beam L200 is converged onto the information recording surface 110A of an optical disk 110 by way of an objective lens 109.

On the other hand, the part of the light beam L200 that is reflected by the information recording surface 110A of the optical disk 110 (to be referred to as reflected light beam L300 hereinafter) is made to enter the ¼ wave plate 108 by way of the objective lens 109 and transformed into linearly polarized light by the ¼ wave plate 108 before it enters the collimator lens 105 by way of an upturn mirror 107.

Then, the collimator lens 105 transforms the incident reflected light beam L300 into convergent light and irradiates a multi-lens 111 with it by way of the beam splitter 104. The multi-lens 111 converges the incident reflected light beam L300 onto the light receiving surface 112A of a light receiving element 112, giving astigmatism to the incident reflected light beam L300.

With the above-described arrangement, the optical disk apparatus operates for tracking control and focusing control according to various signals including a focusing error signal, a tracking error signal and an radio frequency (RF) signal that are output from the light receiving element 112 according to the reflected light beam L300 that is incident to the light receiving surface 112A of the light receiving element 112 and acquires reproduced data.

There are known optical disk apparatus provided with an optical pickup 101 having an objective lens 109 showing a diffraction lens structure and adapted to emit a light beam L100 typically from a laser diode 102 with a wavelength that matches the optical disk 110 to be used with it that is selected from optical disks of different types including a compact disc (CD) and a digital versatile disc (DVD) and diffract the light beam L200 produced from the light beam L100 by means of a diffraction grating formed on the objective lens 109 so as to converge the light beam on the information recording surface 110A of the optical disk 110 (see, for example, Jpn. Pat. Appln. Laid-Open Publication No. 10-199026).

### SUMMARY OF THE INVENTION

Meanwhile, Blu-ray discs (BDs) have been developed to meet the need for a higher recording density and a larger capacity in recent years. Therefore, there is a demand for optical disk apparatus that can record information on and reproduce information from optical disks of the three different types including CDs, DVDs and BDs.

However, optical disks 110 of the three different types including CDs, DVDs and BDs differ from each other in terms of the thickness of the cover substrate layer and the wavelength of the light beam emitted from the laser diode of the optical disk apparatus. More specifically, the cover substrate layer of CDs is 1.2 mm thick and that of DVDs is 0.6 mm thick, while that of BDs is 0.1 mm thick. The wavelength of the light beam L100 emitted from the laser diode 102 is 780 nm for CDs, 650 nm for DVDs and 407 nm for BDs. Therefore, it is necessary to correct the spherical aberration produced by a light beam due to the difference of thickness of cover glass and the difference of wavelength of the light beam L200 that is produced from the light beam L100 and converge the light beam on each of the information recording surfaces 110A of the optical disks 110.

Now, referring to FIGS. 2A through 2C, it may be conceivable to solve this problem by arranging a diffraction element 111 at the side of the light receiving surface 109A of the objective lens 109 so as to correct the spherical aberration attributable to the difference of thickness of the cover substrate layers of optical disks 110 of the three different types including CDs, DVDs and BDs and also the spherical aberration attributable to the difference of wavelength of the light beam L200 and converge the light beam L200 onto the information recording surfaces 110A of the respective optical disks 110.

However, it is extremely difficult to design a diffraction element 111 that can correct the spherical aberration attributable to the difference of thickness of the cover substrate layers of optical disks 100 including CDs, DVDs and BDs and also the spherical aberration attributable to the difference of wavelength of the light beam L200. For example, if the diffraction efficiency is optimized for the thickness of the cover substrate layer of an optical disk 110 of one of the three different types and the wavelength of the corresponding light beam L200, it may be out of optimization for the thickness of the cover substrate layers of optical disks 110 of the remaining two types and the wavelength of the corresponding light beams L200 to consequently degrade the recording/reproduction characteristics of optical disk 110 of the remaining two types.

This problem may be dissolved by using a light beam L201 of divergent light (including a power component) in place of the collimated light beam L200 that strikes the objective lens 109 in a CD replay mode for a CD of optical disks 110 of the three different types as shown in FIG. 3A. With this technique, the spherical aberration attributable to the difference of thickness of the cover substrate layers and also the spherical aberration attributable to the difference of wavelength are corrected by utilizing divergent light without utilizing the diffraction effect of the diffraction element 111 when driving the CD of the optical disks 110, for reproduction of information. On the other hand, the spherical aberration is corrected and the diffraction efficiency is improved by means of the diffraction element 111 when a DVD or a BD out of optical disks 110 of the three different types is driven to reproduce information.

However, with this technique, the finite magnification of the light beam L201 of divergent light is reduced when the light beam L201 of divergent light is made to enter the objective lens 109 obliquely by driving the objective lens 109 for a tracking operation as shown in FIG. 3B. Then, impermissible coma arises due to the tracking operation and, as a result, the recording/reproduction characteristics of the CD are degraded among optical disks 110 of the three different types due to a deformed profile of light spot on the information recording surface 110A of the optical disk 110.

In view of the above-identified circumstances, it is therefore the object of the present invention to provide an optical pickup and an optical disk apparatus that can improve the recording/reproduction characteristics of optical disks of a plurality of different types.

In an aspect of the present invention, the above object and other objects of the invention are achieved by providing an optical pickup adapted to operate for optical disks of a plurality of different types, the optical pickup including: a light source for emitting a first light beam with a wavelength matching a first optical disk or a second light beam with a wavelength matching a second optical disk; an objective lens for converging the first light beam or the second light beam emitted from the light source onto the recording surface of the first optical disk or the second optical disk, whichever appropriate; and a first aberration correcting means arranged on the light path of the first light beam between the light source and the objective lens to generate an aberration for canceling the coma arising due to the objective lens.

In another aspect of the present invention, there is provided an optical pickup adapted to operate for optical disks of a plurality of different types showing different thicknesses for the transparent substrate for receiving a light beam, the optical pickup including: a light source for selectively emitting a first light beam with a wavelength matching a first optical disk or a second light beam with a wavelength matching a second optical disk; an objective lens for converging the first light beam or the second light beam emitted from the light source onto the recording surface of the first optical disk or the second optical disk, whichever appropriate; and a first aberration correcting means arranged on the light path of the first light beam between the light source and the objective lens to generate an aberration for canceling the coma arising due to the objective lens; the first aberration correcting means transforming the first light beam emitted from the light source from collimated light into a wave front having the profile of the first aberration correcting means and containing a power component.

In still another aspect of the present invention, there is provided an optical disk apparatus equipped with an optical pickup adapted to operate for optical disks of a plurality of different types, the apparatus including: a light source for emitting a first light beam with a wavelength matching a first optical disk or a second light beam with a wavelength matching a second optical disk; an objective lens for converging the first light beam or the second light beam emitted from the light source onto the recording surface of the first optical disk or the second optical disk, whichever appropriate; and a first aberration correcting means arranged on the light path of the first light beam between the light source and the objective lens to generate an aberration for canceling the coma arising due to the objective lens.

Thus, an optical pickup adapted to operate for optical disks of a plurality of different types according to the present invention includes a light source for emitting a first light beam with a wavelength matching a first optical disk or a second light beam with a wavelength matching a second optical disk, an objective lens for converging the first light beam or the second light beam emitted from the light source onto the recording surface of the first optical disk or the second optical disk, whichever appropriate, and a first aberration correcting means arranged on the light path of the first light beam between the light source and the objective lens to generate an aberration for canceling the coma arising due to the objective lens. Then, the first light beam is converged onto the first optical disk by way of the first aberration correcting means and the objective lens, whereas the second light beam is converged onto the second optical disk by way of the objective lens so that a light beam can be constantly converged to the diffraction limit for a converged light spot if optical disks of a plurality of different types are involved. Thus, according to the present invention, it is possible to realize an optical pickup that can improve the recording/reproduction characteristics for optical disks of a plurality of different types.

Similarly, an optical disk apparatus equipped with an optical pickup adapted to operate for optical disks of a plurality of different types according to the invention includes a light source for emitting a first light beam with a wavelength matching a first optical disk or a second light beam with a wavelength matching a second optical disk, an objective lens for converging the first light beam or the second light beam emitted from the light source onto the recording surface of the first optical disk or the second optical disk, whichever appropriate, and a first aberration correcting means arranged on the light path of the first light beam between the light source and the objective lens to generate an aberration for canceling the coma arising due to the objective lens. Then, the first light beam is converged onto the first optical disk by way of the first aberration correcting means and the objective lens, whereas the second light beam is converged onto the second optical disk by way of the objective lens so that a light beam can be constantly converged to the diffraction limit for a converged light spot if optical disks of a plurality of different types are involved. Thus, according to the present invention, it is possible to realize an optical disk apparatus that can improve the recording/reproduction characteristics for optical disks of a plurality of different types.

The nature, principle and utility of the invention will become more apparent from the following detailed description when read in conjunction with the accompanying drawings in which like parts are designated by like reference numerals or characters.

### BRIEF DESCRIPTION OF THE DRAWINGS

In the accompanying drawings:

FIG. 1 is a schematic illustration of a known optical pickup, showing the configuration thereof;

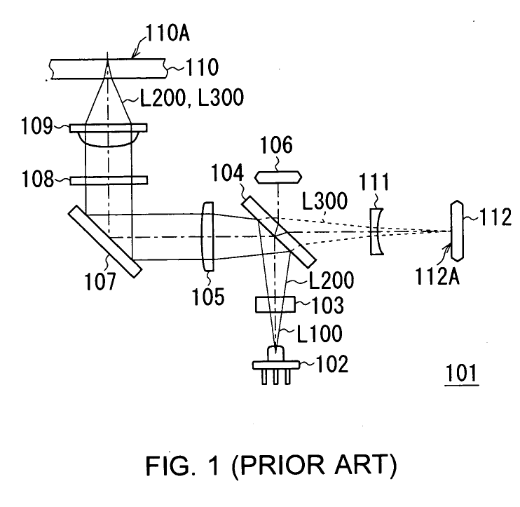

FIGS. 2A through 2C are schematic illustrations of a known optical pickup, showing the configuration thereof more specifically than FIG. 1;

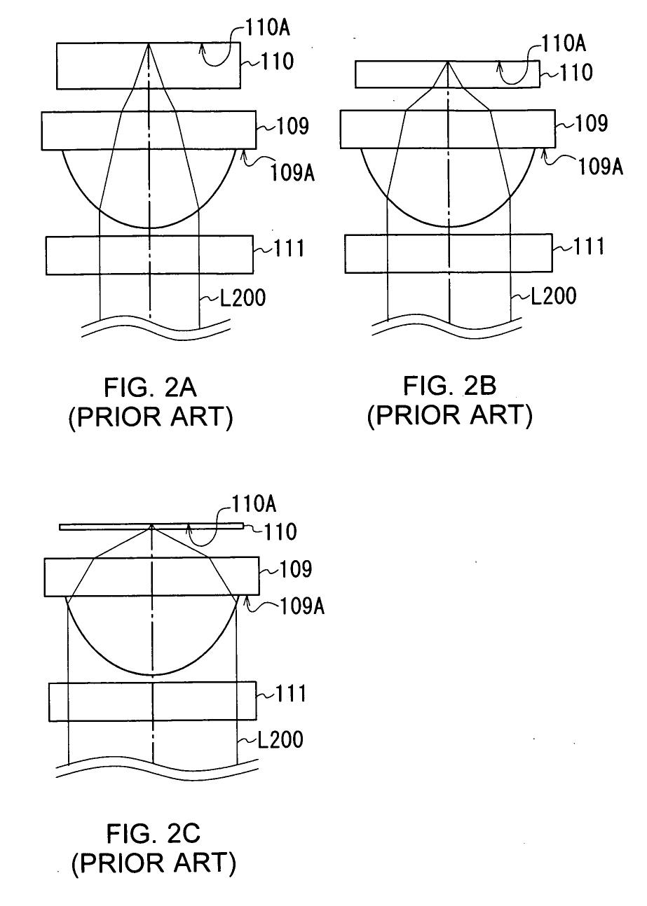

FIGS. 3A and 3B are schematic illustrations of the coma that arises due to a tracking operation of a known optical pickup;

FIG. 4 is a schematic illustration of an embodiment of optical pickup according to the invention, showing the configuration thereof;

FIG. 5 is a schematic illustration of insertion and removal of the field correcting lens of the embodiment of FIG. 4 in the CD replay mode;

FIGS. 6A and 6B are schematic illustrations of the aberration correcting element of the embodiment of FIG. 4, showing the specific configuration thereof;

FIG. 7 is a schematic illustration of the aberration correcting element of the embodiment of FIG. 4, showing the specific configuration thereof;

FIG. 8 is a schematic illustration of the field correcting lens, the objective lens and the CD cover glass of the embodiment of FIG. 4, showing the specific configuration thereof;

FIG. 9 is a graph illustrating the relationship of the field turn and the aberration of the embodiment of FIG. 4;

FIG. 10 is a graph illustrating the relationship of the field turn and the aberration of a known optical pickup;

FIG. 11 is a schematic illustration of insertion and removal of the field correcting lens of the embodiment of FIG. 4 in the DVD replay mode;

FIG. 12 is a schematic illustration of insertion and removal of the field correcting lens of the embodiment of FIG. 4 in the BD replay mode;

FIG. 13 is a schematic illustration of an embodiment of optical disk apparatus according to the invention, showing the configuration thereof;

FIG. 14 is a schematic illustration of insertion and removal of the field correcting lens of the embodiment of FIG. 13;

FIG. 15 is a schematic illustration of the switch between the field correcting lens and the magnification conversion element of the embodiment of FIG. 13; and

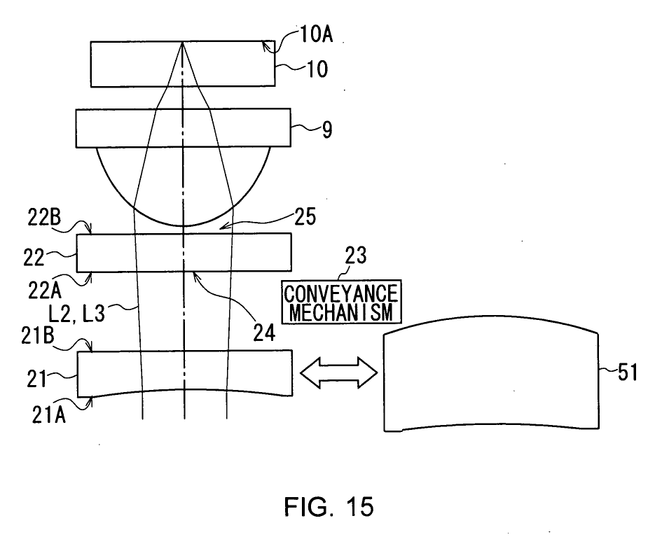

FIG. 16 is another schematic illustration of the switch between the field correcting lens and the magnification conversion element of the embodiment of FIG. 13.

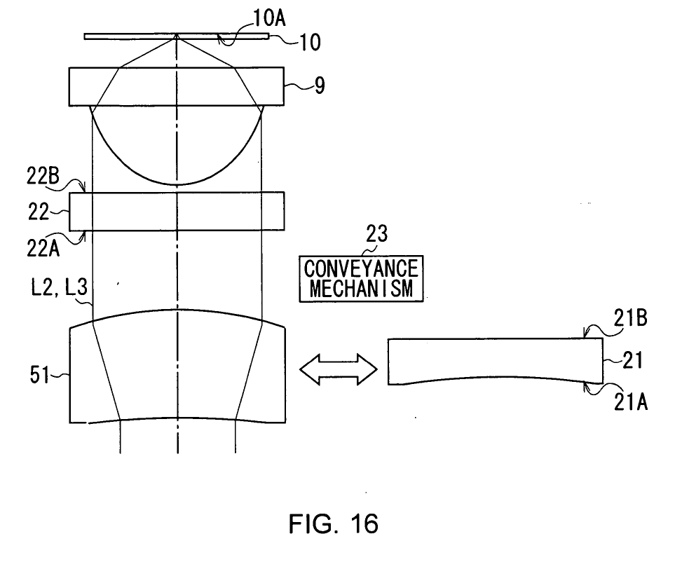

### DETAILED DESCRIPTION OF THE PREFERRED EMBODIMENTS

Now, the present invention will be described in greater detail by referring to the accompanying drawings that illustrate a preferred embodiment of the invention.

(1) Configuration of the Optical Pickup of this Embodiment

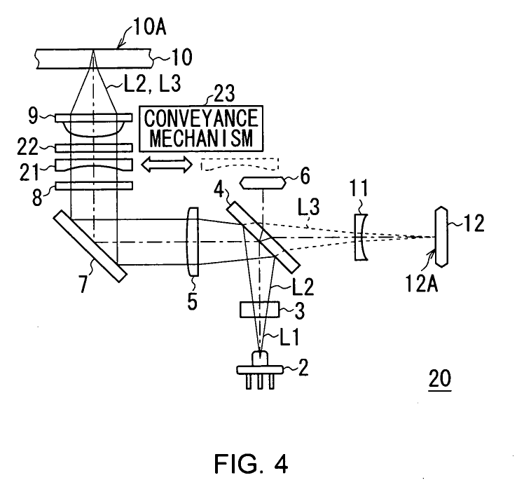

Referring to FIG. 4, reference symbol 20 generally denotes the optical pickup of this embodiment that includes a laser diode 2 that emits a light beam L1 with a wavelength that matches the optical disk of any of three different types to be used with the embodiment, which may be a CD, a DVD or a BD, an upturn mirror 7, an objective lens 9 and so on. Additionally, a field correcting lens 21 that operates as a first aberration correcting means and an aberration correcting element 22 that operates as a second aberration correcting means are arranged between the upturn mirror 7 and the objective lens 9. Furthermore, a conveyance mechanism 23 for removably inserting the field correcting lens 21 is provided. The cover substrate layers of optical disks of the three different types differ from each other in terms of thickness. More specifically, the cover substrate layer of a CD is 1.2 mm thick, that of a DVD is 0.6 mm thick and that of a BD is 0.1 mm thick.

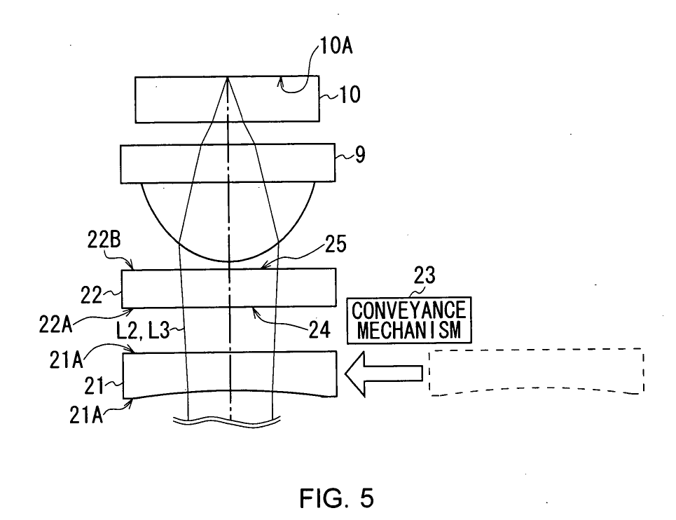

More specifically, referring to FIG. 5, in a CD replay mode for replaying a CD, the light beam L1 emitted from the laser diode 2 with a wavelength that matches the CD (780 nm) is divided into a main beam and two side beams (to be collectively referred to simply as light beam L2 hereinafter) through a grating lens 3 and subsequently collimated. Then, the collimated light beam L2 is made to enter the field correcting lens 21 by way of a beam splitter 4, a collimator lens 5, an upturn mirror 7 and a ¼ wave plate 8.

As shown in FIG. 5, the field correcting lens 21 is formed by using a transparent base member that is typically made of glass and has a light receiving surface 21A showing a predetermined curved profile and a flat light emitting surface 21B so as to operate as an aspheric type lens.

With this arrangement, the field correcting lens 21 transforms the incident light beam L2 from collimated light into divergent light (a wave front having the curved profile of the field correcting lens 21 and containing a power component) according to the curved profile of the field correcting lens 21 and emits it to the aberration correcting element 22. Thus, the spherical aberration attributable to the difference of thickness of cover substrate layer among optical disks 10 and the spherical aberration attributable to the difference of wavelength are corrected by utilizing the divergent light.

As shown in FIG. 5, the aberration correcting element 22 is formed by using a transparent base member that is typically made of glass and has a light receiving surface 22A and a light emitting surface 22B both of which are flat.

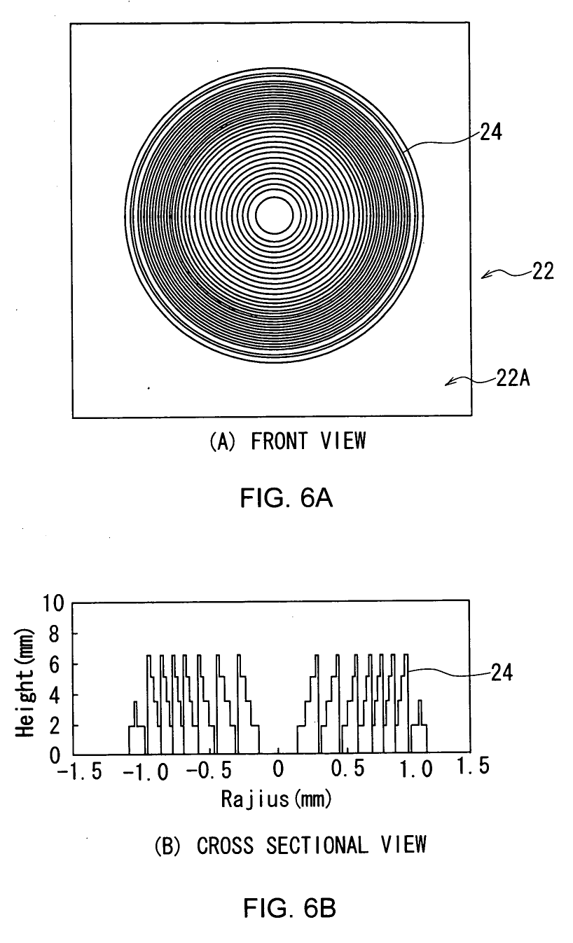

Now, referring to FIG. 6, the light receiving surface 22A of the aberration correcting element 22 is formed by concentrically laying circular diffraction elements 24 one on the other, each having a predetermined wavelength selecting property, to make them show respective heights. For example, one of them transmits a light beam L2 with a wavelength (407 nm) good for BDs and a light beam L2 with a wavelength good for CDs without diffracting them but diffracts a light beam L2 with a wavelength (680 nm) good for DVDs. Thus, with this arrangement, in a CD replay mode or a BD replay mode for replaying a CD or a BD, whichever appropriate, among optical disks 10 of the three different types for instance, it is possible to converge the light beam L2 on the information recording surface 10A of the optical disk 10 with a larger quantity of light without using diffraction, if compared with an arrangement for transforming the incident light beam L2 from collimated light into diffracted light and converging it onto the information recording surface 10A of the optical disk 10.

Thus, with this arrangement, the aberration correcting element 22 diffracts only the light beam L2 with a wavelength good for DVDs when it is transmitted through the diffraction element 24 to correct the spherical aberration of the light beam L2 with a wavelength good for DVDs relative to the objective lens 9.

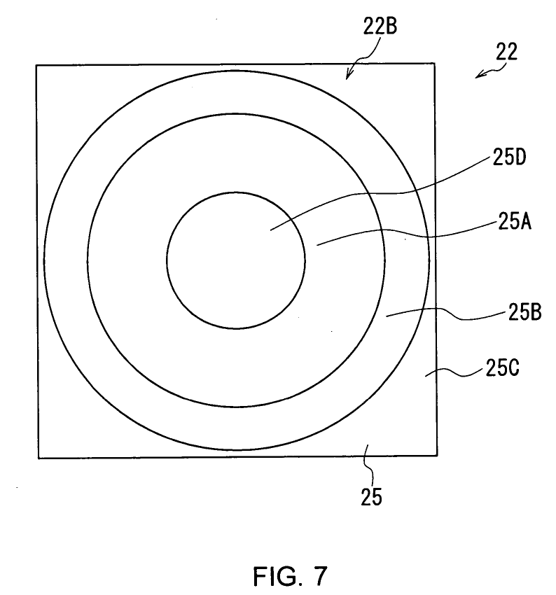

Additionally, as shown in FIG. 7, wavelength filtering films 25 for a plurality of different wavelengths, each having a predetermined wavelength selecting property, are applied to the light emitting surface 22B of the aberration correcting element 22.

The wavelength filtering films 25 are typically arranged in a manner as described below. A first wavelength filtering film 25A is arranged outside a central circular region 25D that defines the numerical aperture of the objective lens 9 to be equal to 0.45 and inside a circular region that defines the numerical aperture of the objective lens 9 to be equal to 0.6 so as to substantially totally transmit a light beam L2 with a wavelength good for DVDs and a light beam with a wavelength good for BDs but substantially totally reflect a light beam L2 with a wavelength good for CDs and a second wavelength filtering film 25B is arranged outside the circular region that defines the numerical aperture of the objective lens 9 to be equal to 0.6 and inside a circular region that defines the numerical aperture of the objective lens 9 to be equal to 0.85 so as to substantially totally transmit a light beam L2 with a wavelength good for BDs but substantially totally reflect a light beam L2 with a wavelength good for DVDs and a light beam L2 with a wavelength good for CDs, whereas a third wavelength filtering film 25C is arranged outside the circular region that defines the numerical aperture of the objective lens to be equal to 0.85 so as to substantially totally reflect a light beam L2 with a wavelength good for BDs, a light beam L2 with a wavelength good for DVDs and a light beam L2 with a wavelength good for CDs.

With this arrangement, the aberration correcting element 22 can select a light beam with a wavelength good for BDs as a light beam L2 that matches the numerical aperture of 0.85 and a light beam with a wavelength good for DVDs as a light beam L2 that matches the numerical aperture of 0.6, while it can select a light beam with a wavelength good for CDs as a light beam L2 that matches the numerical aperture of 0.45.

Thus, the optical pickup 20 transforms the light beam L2 with a wavelength good for CDs that is incident to the field correcting lens 21 from collimated light into divergent light so as to correct the spherical aberration attributable to the difference of thickness of cover substrate layer and the spherical aberration attributable to the difference of wavelength and emits it to the aberration correcting element 22. Then, it limits the aperture for the divergent light beam L2 entering the aberration correcting element 22 in order to make it match a numerical aperture of 0.45 and converges it onto the information recording surface 10A of the optical disk 10 by means of the objective lens 9.

Note that the curved profile of the field correcting lens 21 is so defined as to be non-aberrant relative to CDs, one of the three different types of optical disks 10.

Thus, as a light beam L2 with a wavelength good for CDs is converged onto the information recording surface 10A of the optical disk 10 by way of the field correcting lens 21, the aberration correcting element 22 and the objective lens 9, the optical pickup 20 can converge the converged light spot to the diffraction limit on the information recording surface 10A.

Subsequently, after making the reflected light beam L3 reflected by the CD, or the optical disk 10, enter the field correcting lens 21 by way of the objective lens 9 and the aberration correcting element 22, the optical pickup 20 converges the light beam L3 onto the light receiving surface 12A of the light receiving element 12 by way of the ¼ wave plate 8, the upturn mirror 7, the collimator lens 5, the beam splitter 4 and the multi-lens 11 as in the above-described replay mode.

Additionally, the optical pickup 20 corrects the coma that arises in a tracking operation where the objective lens 9 is moved in a radial direction of the optical disk 10 and in parallel with the recording surface of the optical disk 10 in a CD replay mode.

More specifically, when the field of view of the objective lens 9 is driven to turn in a tracking operation of moving the objective lens 9, the optical pickup 20 corrects the coma that arises due to the light beam L2 entering the objective lens 9 obliquely in the tracking operation of moving the objective lens 9 as it is cancelled by the coma that arises due to the eccentricity of the optical axis of the field correcting lens 21 and that of the objective lens 9.

Thus, even when the light beam L2 that enters the objective lens 9 obliquely is converged onto the information recording surface 10A of the optical disk 10, the optical pickup 20 can converge the converged light spot to the diffraction limit on the information recording surface 10A in a state where the coma is cancelled.

As for the curved profile of the field correcting lens 21, if the height of the optical axis is Y mm, the radius of curvature is R mm, the conical constant is K and the aspheric coefficients of the Y⁴ term, the Y⁶ term, the Y⁸ term, the Y¹⁰ term, the Y¹² term, the Y¹⁴ term and the Y¹⁶ term are respectively A, B, C, D, E, F and G, the depth X mm from the apex of the surface is expressed by the aspheric equation (1) shown below. Thus, the aspheric profile of the field correcting lens 21 can be designed by using the equation.
X=Y²/R/1+{1−(1+k)(Y/R)²}^{1/2}+AY⁴+BY⁶+CY⁸+DY¹⁰+EY¹²+FY¹⁴+GY¹⁶ (1)

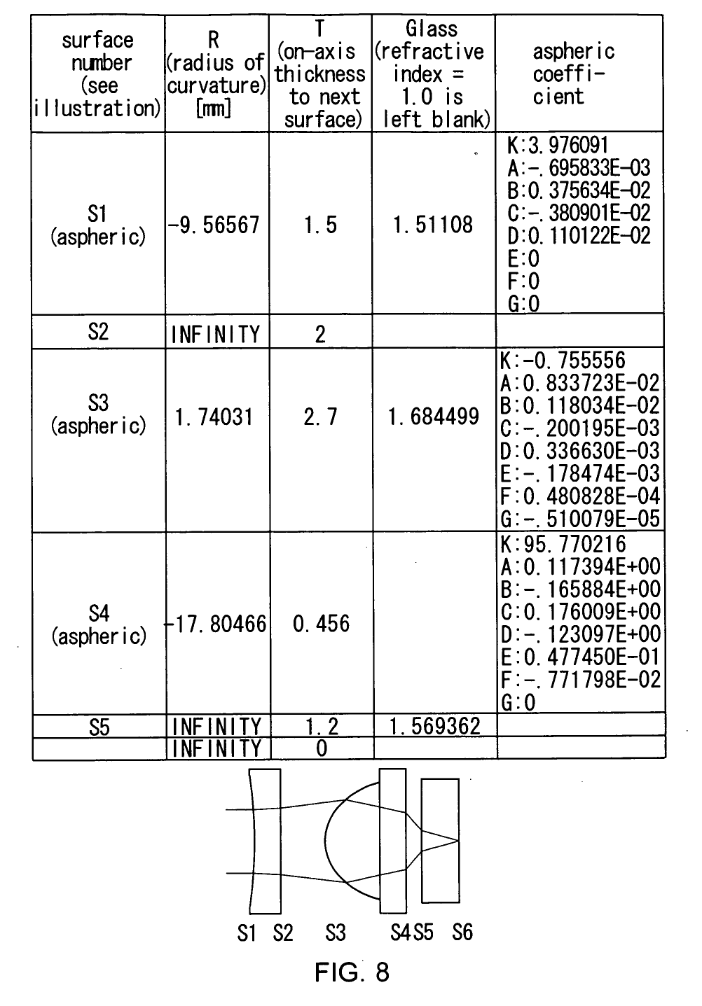

FIG. 8 shows as examples the profile of the light receiving surface 21A, that of the light emitting surface 21B, the radius of curvature, the on-axis thickness to the next surface, the refractive index for a light beam L2 with a wavelength good for CDs and the aspheric constant for a light beam L2 with a wavelength good for CDs of the field correcting lens 21 and those of the objective lens 9.

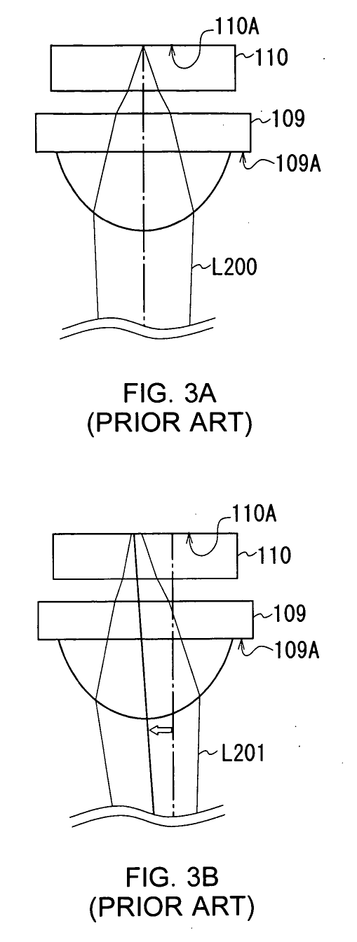

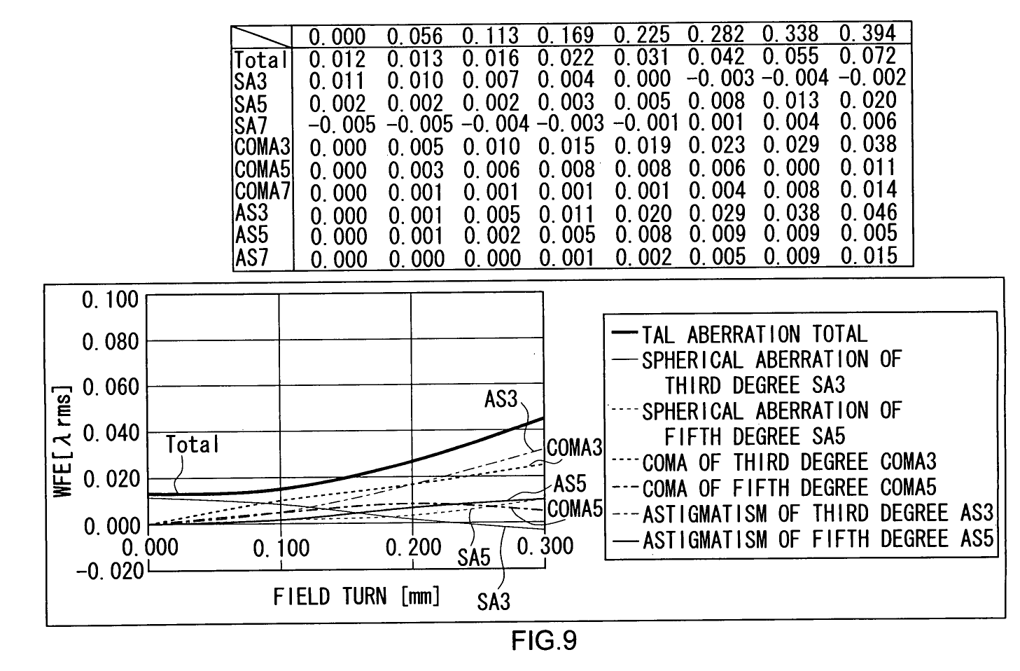

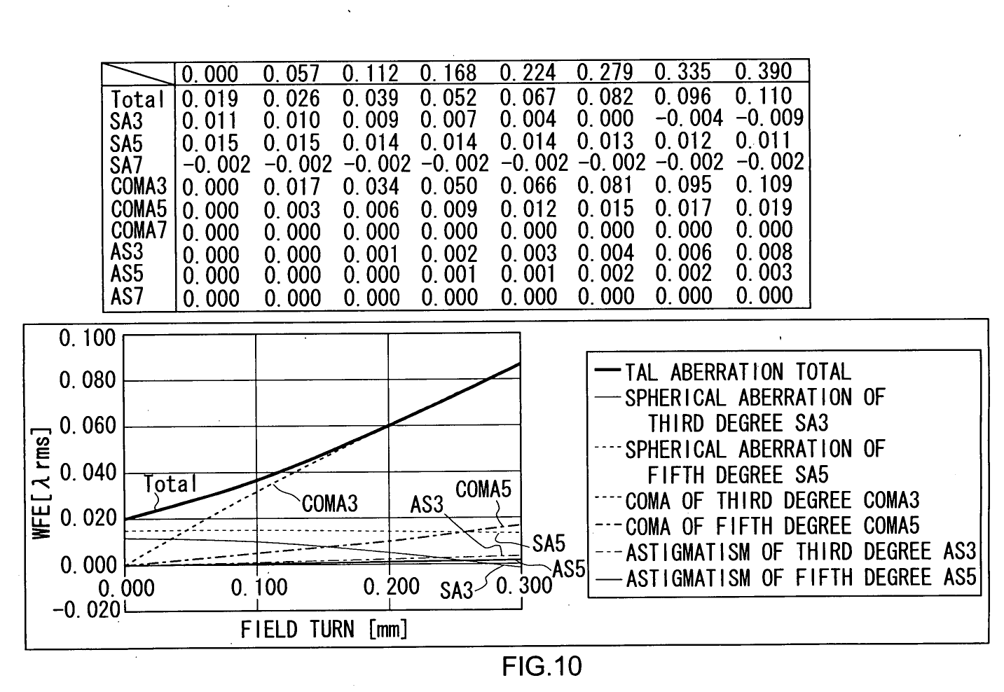

FIG. 9 shows the spherical aberration, the coma and the astigmatism relative to the field turn of the objective lens 9 when the field correcting lens 21, the objective lens 9 and the optical disk 10, which is a CD, are designed in a manner as listed in FIG. 8. On the other hand, FIG. 10 shows the spherical aberration, the coma and the astigmatism relative to the field turn of the objective lens 9 when the light emitting point of the laser diode 2 is separated from the objective lens 9 by 22.82 mm and a light beam L2 of divergent light is made to enter the objective lens 9 without inserting the field correcting lens 21 as shown in FIG. 3.

As seen from the results of the experiment, it is clear that the overall aberration that is observed relative to the field turn of the objective lens 9 when the field correcting lens 21, the objective lens 9 and the optical disk 10, or the CD, are designed in a manner as described above is by far smaller than the overall aberration that is observed relative to the field turn of the objective lens 9 when a light beam L2 of divergent light is made to enter the objective lens 9 from the light emitting point of the laser diode 2 that is separated from the objective lens by 22.82 mm without inserting the field correcting lens 21 as shown in FIG. 3.

Particularly, it was confirmed in the experiment that the coma of the third degree can be reduced remarkably with the above arrangement if compared with the arrangement where a light beam 2 of divergent light is made to enter the objective lens 9 from the light emitting point of the laser diode 2 that is separated from the objective lens 9 by 22.82 mm without inserting the field correcting lens 21 as shown in FIG. 3.

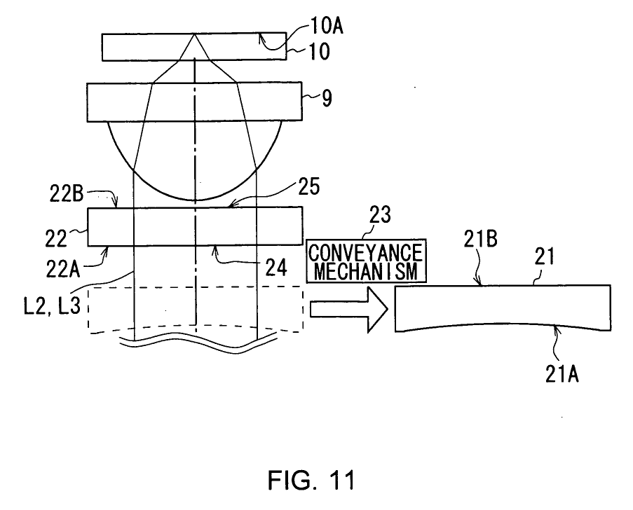

On the other hand, in a DVD replay mode for replaying a DVD as optical disk 10 as shown in FIG. 11, the optical pickup 20 divides the light beam L1 emitted from the laser diode 2 with a wavelength good for DVDs (650 nm) to produce a light beam L2 as in the case of the above-described replay mode by way of a grating lens 3. The light beam L2 is then collimated and made to enter the aberration correcting element 22 by way of the beam splitter 4, the collimator lens 5, the upturn mirror 7 and the ¼ wave plate 8.

At this time, as may be clear from FIG. 11, the optical pickup 20 drives the conveyance mechanism 23 to pull out the field correcting lens 21 from between the upturn mirror 7 and the aberration correcting element 22.

The aberration correcting element 22 diffracts the incident light beam L2 with a wavelength good for DVDs by means of the deflection element 24 and makes it match the numerical aperture of 0.6 by limiting the aperture before it converges the light beam onto the information recording surface 10A of the optical disk 10 by way of the objective lens 9.

Thus, in this way, when the light beam L2 with a wavelength good for DVDs is converged onto the information recording surface 10A of the optical disk 10 by way of the aberration correcting element 22 and the objective lens 9, the optical pickup 20 can converge the converged light spot to the diffraction limit on the information recording surface 10A.

Subsequently, after making the reflected light beam L3 enter the aberration correcting element 22 by way of the objective lens 9, the optical pickup 20 converges the light beam L3 onto the light receiving surface 12A of the light receiving element 12 by way of the ¼ wave plate 8, the upturn mirror 7, the collimator lens 5, the beam splitter 4 and the multi-lens 11 as in the case of the above-described replay mode. Thus, the light beam L2 with a wavelength good for DVDs is diffracted by the diffraction elements 24 to correct the spherical aberration attributable to the difference of thickness of the cover substrate layer of the optical disk 10, or the DVD, and also the spherical aberration attributable to the difference of wavelength.

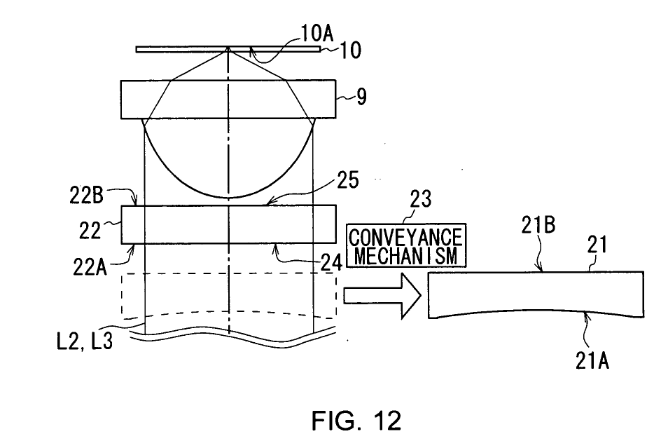

On the other hand, referring to FIG. 12, in a BD replay mode for replaying a BD, the light beam L1 emitted from the laser diode 2 with a wavelength that matches the BD (407 nm) is divided to produce a light beam L2 by way of the grating lens 3 as in the case of the above-described replay mode. Then, the collimated light beam L2 is made to enter the aberration correcting element 22 by way of the beam splitter 4, the collimator lens 5, the upturn mirror 7 and the ¼ wave plate 8.

At this time, as may be clear from FIG. 12, the optical pickup 20 drives the conveyance mechanism 23 to pull out the field correcting lens 21 from between the upturn mirror 7 and the aberration correcting element 22 as in the case of the above-described DVD mode.

Then, the aberration correcting element 22 makes the incident light beam L2 match the numerical aperture of 0.85 by limiting the aperture before it converges the light beam onto the information recording surface 10A of the optical disk 10 by way of the objective lens 9.

Thus, in this way, when the light beam L2 with a wavelength good for BDs is converged onto the information recording surface 10A of the optical disk 10 by way of the aberration correcting element 22 and the objective lens 9, the optical pickup 20 can converge the converged light spot to the diffraction limit on the information recording surface 10A. Note that the optical pickup 20 of this embodiment is optimally adapted to replay a BD as optical disk 10 without requiring the diffraction effect of the aberration correcting element 22 for correcting the spherical aberration attributable to the difference of thickness of the cover substrate layer of the optical disk 10, or the BD, and also the spherical aberration attributable to the difference of wavelength that arise when a light beam L2 with a wavelength that matches BDs is emitted.

Subsequently, after making the reflected light beam L3 enter the aberration correcting element 22 by way of the objective lens 9, the optical pickup 20 converges the light beam L3 onto the light receiving surface 12A of the light receiving element 12 by way of the ¼ wave plate 8, the upturn mirror 7, the collimator lens 5, the beam splitter 4 and the multi-lens 11 as in the case of the above-described replay mode.

(2) Configuration of an Embodiment of Optical Disk Apparatus

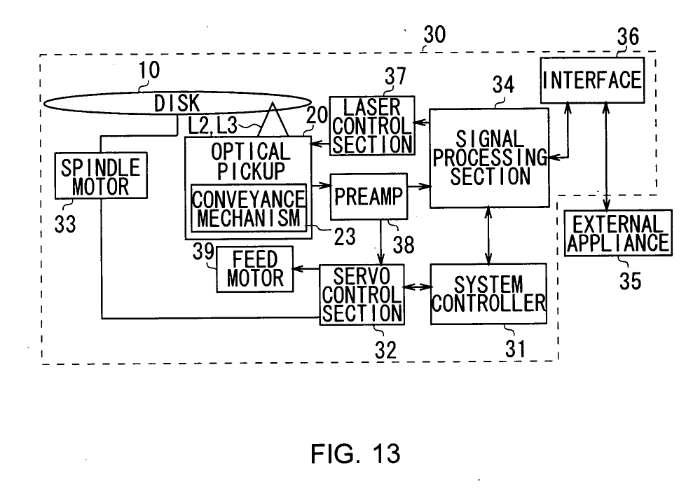

FIG. 13 is a schematic illustration of an embodiment of optical disk apparatus 30 according to the invention realized by applying an optical pickup 20 according to the invention as described above. The optical disk apparatus 30 records data on and reproduces data from a CD, a DVD or a BD.

More specifically, in a recording mode, system controller 31 of the optical disk apparatus 30 controls and drives a spindle motor 33 by way of a servo control section 32 so as to cause the optical disk 10 mounted in the optical disk apparatus 30 to rotate in a predetermined state.

At this time, the signal processing section 34 of the optical disk apparatus 30 is supplied with various data necessary for the recording operation including video/audio data and computer data from an external appliance 35 by way of interface 36. Then, the signal processing section 34 processes the supplied data for modulation and other purposes and applies the obtained data to be recorded to laser control section 37 as laser drive data.

The laser control section 37 drives the laser diode 2 (FIG. 4) in the optical pickup 10 to make it flash with a predetermined power level according to the laser drive data supplied to it. As a result, a light beam L2 is emitted from the optical pickup 20 to flash according to the flashing operation of the laser diode 2 and irradiate the optical disk 10. Thus, as a result, data are recorded on the optical disk 10.

At the same time, the optical pickup 10 applies various signals output from the light receiving element 12 (FIG. 4) according to the reflected light beam L3 produced from the light beam L2 as it is reflected by the optical disk 10 to preamp 38.

The preamp 38 then generates a focusing error signal, a tracking error signal and an RF signal according to the supplied various signals and transmits the focusing error signal and the tracking error signal to the servo control section 32 and the RF signal to the signal processing section 34.

Thus, whenever necessary, the servo control section 32 drives a feed motor 39 for moving the optical pickup 10 in a radial direction of the optical disk 10 and a biaxial actuator (not shown) for holding the objective lens 9 in the optical pickup 10 according to the focusing error signal and the tracking error signal supplied to it so as to make the light beam L2 emitted from the optical pickup 20 to be correctly focused on and follow the right track on the information recording surface 10A of the optical disk 10.

In a replay mode, on the other hand, the system controller 31 of the optical disk apparatus 30 controls and drives the spindle motor 33 by way of the servo control section 32 so as to cause the optical disk 10 mounted in the optical disk apparatus 30 to rotate in a predetermined state as in a recording mode.

The laser control section 37 drives the laser diode 2 (FIG. 4) in the optical pickup 10 to make it flash with a predetermined power level. As a result, a light beam L2 is emitted from the optical pickup 20 toward the optical disk 10 continuously and the various signals output from the light receiving element 12 (FIG. 4) according to the reflected light beam L3 produced as the light beam L2 is reflected by the optical disk 10 are applied to preamp 38.

Then, as in a recording mode, the preamp 38 generates a focusing error signal, a tracking error signal and an RF signal according to the supplied various signals and transmits the focusing error signal and the tracking error signal to the servo control section 32 and the RF signal to the signal processing section 34.

Thus, as in a recording mode, the optical disk apparatus 30 operates for focusing control and tracking control according to the focusing error signal and the tracking error signal under the control of the servo control section 32.

Additionally, the signal processing section 34 processes the RF signal supplied to it in a predetermined manner for demodulation, error correction and so on and transmits the obtained data to be reproduced to the external appliance 35 by way of the interface 36.

In this way, the optical disk apparatus 30 can record data on and reproduce data from the optical disk 10.

In addition to the above-described arrangement, the optical disk apparatus 30 detects the optical disk 10 to be used for recording data or reproducing data and finds out if it is a CD, a DVD or a BD in a recording mode or in a replay mode, whichever appropriate. Then, it generates a disk detection data and transmits it to the signal processing section 32.

In a recording mode, the signal processing section 32 applies laser drive data indicating the wavelength that corresponds to the disk detection data supplied from the optical pickup 20 to the laser control section 38. Then, the laser control section 38 drives the laser diode 2 (FIG. 4) in the optical pickup 20 so as to make it flash with a predetermined power level with the wavelength that matches the optical disk 10 according to the supplied laser drive data.

On the other hand, in a replay mode, the signal processing section 32 applies laser drive data indicating the wavelength that corresponds to the disk detection data supplied from the optical pickup 20 to the laser control section 38. Thus, the laser control section 38 can turn on the laser diode 2 (FIG. 4) in the optical pickup 20 with a predetermined power level with the wavelength that matches the optical disk 10 described above.

Then, the signal processing section 34 transfers the disk detection data supplied from the optical pickup 20 to the system controller 31.

The system controller 31 controls the conveyance mechanism 23 by way of the servo control section 32 according to the disk detection data so that it drives the conveyance mechanism 23 to insert the field correcting lens 21 (FIG. 4) between the upturn mirror 7 (FIG. 4) and the aberration correcting element 22 (FIG. 4) when the optical disk apparatus 30 drives a CD as optical disk 10 for recording or replaying, whereas it drives the conveyance mechanism 23 to pull out the field correcting lens 21 (FIG. 4) from between the upturn mirror 7 (FIG. 4) and the aberration correcting element 22 (FIG. 4) when the optical disk apparatus 30 drives a DVD or a BD as optical disk 10.

In this way, the optical disk apparatus 30 drives the conveyance mechanism 23 so as to insert the field correcting lens 21 (FIG. 4) between the upturn mirror 7 (FIG. 4) and the aberration correcting element 22 (FIG. 4) or pull out the field correcting lens 21 (FIG. 4) from between the upturn mirror 7 (FIG. 4) and the aberration correcting element 22 (FIG. 4) depending on the type of the optical disk 10 mounted in it. Thus, it converges the light beam L2 with a wavelength good for CDs onto the information recording surface 10A of the optical disk 10 by way of the field correcting lens, the aberration correcting element and the objective lens in a CD replay mode, whereas it converges the light beam L2 with a wavelength good for DVDs or BDs onto the information recording surface 10A of the optical disk 10 by way of the aberration correcting element and the objective lens in a DVD replay mode or in a BD replay mode, whichever appropriate, so that it can always converge the converged light spot to the diffraction limit on the information recording surface 10A.

(3) Operation and Advantages of this Embodiment

With the above-described arrangement, when the optical disk apparatus 30 drives the conveyance mechanism 23 to insert the field correcting lens 21 between the upturn mirror 7 and the aberration correcting element 22 and also drives the objective lens 9 for a tracking operation, it is possible to correct the coma that arises due to the tracking operation of the objective lens 9 without the field correcting lens 21 by canceling it by the coma that arises due to the eccentricity of the optical axis of the field correcting lens 21 and that of the objective lens 9.

Thus, the optical disk apparatus 30 converges the light beam L2 with a wavelength good for CDs onto the information recording surface 10A of the optical disk 10 by way of the field correcting lens 21, the aberration correcting element 22 and the objective lens 9 in a CD replay mode, whereas it converges the light beam L2 with a wavelength good for DVDs or BDs onto the information recording surface 10A of the optical disk 10 by way of the aberration correcting element 22 and the objective lens 9 in a DVD replay mode or in a BD replay mode, whichever appropriate, so that it can always converge the converged light spot to the diffraction limit on the information recording surface 10A.

With the above-described arrangement, when the optical disk apparatus 30 drives the conveyance mechanism 23 to insert the field correcting lens 21 between the upturn mirror 7 and the aberration correcting element 22 and also drives the objective lens 9 for a tracking operation, it is possible to correct the coma that arises due to the tracking operation of the objective lens 9 without the field correcting lens 21 by canceling it by the coma that arises due to the eccentricity of the optical axis of the field correcting lens 21 and that of the objective lens 9. Thus, the optical disk apparatus 30 converges the light beam L2 with a wavelength good for CDs onto the information recording surface 10A of the optical disk 10 by way of the field correcting lens 21, the aberration correcting element 22 and the objective lens 9 in a CD replay mode, whereas it converges the light beam L2 with a wavelength good for DVDs or BDs onto the information recording surface 10A of the optical disk 10 by way of the aberration correcting element 22 and the objective lens 9 in a DVD replay mode or in a BD replay mode, whichever appropriate, so that it can always converge the converged light spot to the diffraction limit on the information recording surface 10A. Therefore, it is possible to realize an optical disk apparatus with improved recording/reproduction characteristics for optical disks of a plurality of different types.

(4) Other Embodiments

While the above embodiments are described in terms of a replay mode for replaying an optical disk 10, which may be a CD, a DVD or a BD, the present invention is by no means limited thereto. In other words, the above description is substantially applied to a recording mode for recording information on an optical disk 10, which may be a CD, a DVD or a BD.

While the above embodiments are described in terms of recording data on a predetermined first optical disk or a second optical disk that is different from the first optical disk and reproducing data from the first optical disk or the second optical disk, whichever appropriate, by means of an optical pickup, where the first optical disk may be a CD and the second optical disk may be a DVD or a BD, the present invention is by no means limited thereto. In other words, optical disks other than the CD, the DVD and the BD may equally be used for the purpose of the present invention.

While the first aberration correcting means that is arranged on the light path between the light source and the objective lens to generate aberration for canceling the coma that arises due to the objective lens is operated to drive the objective lens 9 to move in a radial direction of the optical disk 10 and in parallel with the recording surface of the optical disk 10 for a tracking operation in the above-described embodiment, the present invention is by no means limited thereto and any of various different techniques such as tilting the objective lens can be applied for the purpose of the present invention in order to cancel the coma that arises due to the objective lens.

While the field correcting lens 21 is arranged as the first aberration correcting means on the light path between the light source and the objective lens to generate aberration for canceling the coma that arises due to the objective lens in the above-described embodiment, the present invention is by no means limited thereto and, for example, a liquid crystal device that operates like the above-described field correcting lens 21 or a some other similar aberration correcting means may alternatively be used for the purpose of the present invention. Particularly, when a liquid crystal device is used, it can control the phase distribution to be applied to the transmitted wave front by controlling the applied voltage according to the wavelength to be used so that it is no longer necessary to insert the field correcting lens 21 or pull it out depending on the wavelength.

While a conveyance mechanism is arranged in the above-described embodiment to drive the field correcting lens 21 in order to insert it and pull it out and the light beam is emitted through the same light path with different wavelengths that match CDs, DVDs and BDs, or optical disks of three different types, respectively and converged on the recording surface, the present invention is by no means limited thereto. For example, a field correcting lens may be arranged between the light source and the objective lens and a detour light path may be provided to bypass the field correcting lens so that a light beam with a wavelength good for CDs, optical disks of a type, is converged on the recording surface of an optical disk, which is a CD, by way of the field correcting lens and the objective lens, whereas a light beam with a wavelength good for DVDs or BDs, optical disks of another type, is converged on the recording surface of an optical disk, which is a DVD or a BD, whichever appropriate, by way of the detour light path where no field correcting lens is arranged. Thus, an optical pickup according to the present invention may be so adapted as to converge a light beam on the recording surface by way of a light path that varies depending on the wavelength of the light beam selected to match optical disks of any of a plurality of various types.

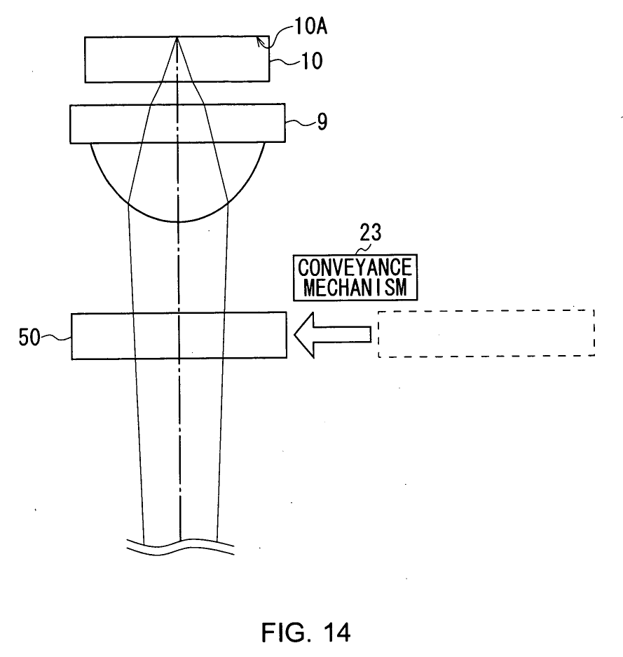

While the field correcting lens 21 arranged between the light source and the objective lens operates for transforming the light beam L2 from a collimated light into divergent light in the above-described embodiment, the present invention is by no means limited thereto. For example, alternatively, the conveyance mechanism 23 may be driven to pull out the collimator lens 5 from between the beams splitter 4 and the upturn mirror 7 or a plurality of laser diodes may be provided in a CD replay mode so that coma may be generated due to the eccentricity of the optical axis of the field correcting lens 21 and that of the objective lens 9 when the light beam L2 of divergent light is made to enter the field correcting lens 50 as shown in FIG. 14 and the objective lens 9 is driven for a tracking operation.

Furthermore, while the conveyance mechanism 23 is driven to insert the field correcting lens 21 between the upturn mirror 7 and the aberration correcting element 22 when replaying a CD as optical disk 10, whereas the conveyance mechanism 23 is driven to pull out the field correcting lens 21 from between the upturn mirror 7 and the aberration correcting element 22 when replaying a DVD or a BD in the above description of the embodiment, the present invention is by no means limited thereto. For example, a magnification conversion element 51 having a predetermined profile alternatively may be inserted between the upturn mirror 7 and the aberration correcting element 22 when replaying a BD as optical disk 10.

With such an arrangement, it is possible to select an optimal optical magnification for any of a plurality of different wavelengths of laser beams whose light emitting points are arranged substantially at a same position to consequently improve the recording/reproduction characteristics.

While the light beam L2 to be used for a CD is transformed from collimated light into divergent light as wave front having the curved profile of the first aberration correcting means and containing a power component in the above-described embodiment, the present invention is by no means limited thereto. For example, any of various wave fronts containing a power component other than divergent light may alternatively be used for the purpose of the present invention.

While diffraction elements 24 are formed on the light receiving surface 22A of the aberration correcting element 22 and wavelength filtering films 25 are applied to the light emitting surface 22B of the aberration correcting element 22 as the second aberration correcting means arranged between the first aberration correcting means and the objective lens in the above-described embodiment, the present invention is by no means limited thereto. For example, alternatively, the aberration may be corrected by means of diffraction, using diffraction filtering films and aperture limiting elements, or by means of an aperture limiting technique.

While a light beam of any of various different wavelengths is transmitted or reflected by means of wavelength filtering films depending on the wavelength that is actually in place in the above-described embodiment, the present invention is by no means limited thereto. For example, alternatively, the light beam of any of various different wavelengths may be transmitted, absorbed or diffracted. What is essential is that any light beams other than the light beam with an effective diameter for CDs, DVDs or BDs do not participate in the converged light spot.

While the optical pickup 20 detects the type of the optical disk 10 to be used for recording/reproduction, in other words, if the optical disk 10 is a CD, a DVD or a BD in the above-described embodiment, the present invention is by no means limited thereto. The type of the optical disk 10 may be detected by means of any appropriate alternative technique.

While the system controller 33 drives the conveyance mechanism 23 by way of the servo control section 32 in the above-described embodiment, the present invention is by no means limited thereto. For example, alternatively, a conveyance means for driving the conveyance mechanism 23 may be provided apart from the system controller 33.

While an optical disk apparatus according to the invention has a configuration as illustrated in FIG. 12 in the above description, the present invention is by no means limited thereto. In other words, an optical disk apparatus according to the invention may have a configuration from the one illustrated and described above.

In short, the present invention can be applied to optical disk apparatuses of a variety of different types.

It should be understood by those skilled in the art that various modifications, combinations, sub-combinations and alterations may occur depending on design requirements and other factors insofar as they are within the scope of the appended claims or the equivalents thereof.

What is claimed is:

1. An optical pickup adapted to operate for optical disks of a plurality of different types, the optical pickup comprising:
a light source for emitting a first light beam with a wavelength matching a first optical disk or a second light beam with a wavelength matching a second optical disk;
an objective lens for converging the first light beam or the second light beam emitted from the light source onto the recording surface of the first optical disk or the second optical disk, whichever appropriate; and
first aberration correcting means arranged on the light path of the first light beam between the light source and the objective lens to cancel the coma arising due to the objective lens.

2. The optical pickup according to claim 1, wherein:
the first light beam or the second light beam is emitted selectively from the light source and converged onto the recording surface of the first optical disk or the second optical disk, whichever appropriate, by way of a same light path; and
the optical pickup further includes
conveyance means for conveying the first aberration correcting means so as to insert it onto the light path of the first light beam and the second light beam between the light source and the objective lens when using the first optical disk for recording/reproduction and pull it out from the light path of the first light beam and the second light beam between the light source and the objective lens when using the second optical disk for recording/reproduction.

3. The optical pickup according to claim 1, wherein
the first aberration correcting means transforms the first light beam emitted from the light source from collimated light into a wave front having the profile of the first aberration correcting means and containing a power component.

4. The optical pickup according to claim 1, further comprising:
second aberration correcting means arranged between the first aberration correcting means and the objective lens; and
the second aberration correcting means diffracts the second light beam, or one of the second light beams of a plurality of different types, so as to converge it onto the recording surface of the corresponding second optical disk but transmitting the first light beam.

5. The optical pickup according to clam 4, wherein
the second aberration correcting means imposes an aperture limit to the first light beam or the second light beam so as to correspond to the numerical aperture for the first light beam or the numerical aperture for the second light beam.

6. The optical pickup according to claim 1, wherein:
the light source emits a third light beam with a wavelength matching a third optical disk; and
the objective lens converges the third light beam onto the recording surface of the third optical disk.

7. The optical pickup according to claim 6, wherein:
the third light beam is converted onto the recording surface of the third optical disk by way of the light path same as that of the first light beam and the second light beam; and
the optical pickup further includes
conveyance means for conveying the first aberration correcting means so as to insert it onto the light path of the first light beam and the second light beam between the light source and the objective lens when using the first optical disk for recording/reproduction and pull it out from the light path of the first light beam and the second light beam between the light source and the objective lens when using the second optical disk for recording/reproduction.

8. The optical pickup according to claim 7, further comprising:
second aberration correcting means arranged between the first aberration correcting means and the objective lens; and
the second aberration correcting means diffracting the second light beam so as to converge it onto the recording surface of the corresponding second optical disk but transmitting the first light beam and the third light beam.

9. An optical pickup adapted to operate for optical disks of a plurality of different types showing different thicknesses for the transparent substrate for receiving a light beam, the optical pickup comprising:
a light source for selectively emitting a first light beam with a wavelength matching a first optical disk or a second light beam with a wavelength matching a second optical disk;
an objective lens for converging the first light beam or the second light beam emitted from the light source onto the recording surface of the first optical disk or the second optical disk, whichever appropriate;
first aberration correcting means arranged on the light path of the first light beam between the light source and the objective lens to cancel the coma arising due to the objective lens; and
the first aberration correcting means transforming the first light beam emitted from the light source from collimated light into a wave front having the profile of the first aberration correcting means and containing a power component.

10. The optical pickup according to claim 9, wherein:
the first light beam or the second light beam is emitted selectively from the light source and converged onto the recording surface of the first optical disk or the second optical disk, whichever appropriate, by way of a same light path; and
the optical pickup further includes
conveyance means for conveying the first aberration correcting means so as to insert it onto the light path of the first light beam and the second light beam between the light source and the objective lens when using the first optical disk for recording/reproduction and pull it out from the light path of the first light beam and the second light beam between the light source and the objective lens when using the second optical disk for recording/reproduction.

11. The optical pickup according to claim 9, further comprising:
second aberration correcting means arranged between the first aberration correcting means and the objective lens; and
the second aberration correcting means diffracting the second light beam, or one of the second light beams of a plurality of different types, so as to converge it onto the recording surface of the corresponding second optical disk but transmitting the first light beam and other second light beam.

12. The optical pickup according to clam 11, wherein
the second aberration correcting means imposes an aperture limit to the first light beam or the second light beam so as to correspond to the numerical aperture for the first light beam or the numerical aperture for the second light beam.

13. An optical disk apparatus equipped with an optical pickup adapted to operate for optical disks of a plurality of different types, the apparatus comprising:
a light source for emitting a first light beam with a wavelength matching a first optical disk or a second light beam with a wavelength matching a second optical disk;
an objective lens for converging the first light beam or the second light beam emitted from the light source onto the recording surface of the first optical disk or the second optical disk, whichever appropriate; and
first aberration correcting means arranged on the light path of the first light beam between the light source and the objective lens to cancel the coma arising due to the objective lens.

14. The apparatus according to claim 13, wherein:
the first light beam or the second light beam is emitted selectively from the light source and converged onto the recording surface of the first optical disk or the second optical disk, whichever appropriate, by way of a same light path; and
the optical disk apparatus further includes
conveyance means for conveying the first aberration correcting means so as to insert it onto the light path of the first light beam and the second light beam between the light source and the objective lens when using the first optical disk for recording/reproduction and pull it out from the light path of the first light beam and the second light beam between the light source and the objective lens when using the second optical disk for recording/reproduction.

15. The apparatus according to claim 13, wherein
the first aberration correcting means transforms the first light beam emitted from the light source from collimated light into a wave front having the profile of the first aberration correcting means and containing a power component.

16. The apparatus according to claim 13, further comprising:
second aberration correcting means arranged between the first aberration correcting means and the objective lens; and
the second aberration correcting means diffracting the second light beam, or one of the second light beams of a plurality of different types, so as to converge it onto the recording surface of the corresponding second optical disk but transmitting the first light beam and other second light beam.

17. The apparatus according to clam 13, wherein
the second aberration correcting means imposes an aperture limit to the first light beam or the second light beam so as to correspond to the numerical aperture for the first light beam or the numerical aperture for the second light beam.

18. The apparatus according to claim 13, wherein:
the light source emits a third light beam with a third wavelength matching a third optical disk;
the third light beam is converted onto the recording surface of the third optical disk by the objective lens by way of the light path same as that of the first light beam and the second light beam; and
the apparatus further includes
conveyance means for conveying the first aberration correcting means so as to insert it onto the light path of the first light beam and the second light beam between the light source and the objective lens when using the first optical disk for recording/reproduction and pull it out from the light path of the first light beam and the second light beam between the light source and the objective lens when using the second optical disk for recording/reproduction.

19. The apparatus according to claim 18, further comprising:
second aberration correcting means arranged between the first aberration correcting means and the objective lens; and
the second aberration correcting means diffracting the second light beam so as to converge it onto the recording surface of the corresponding second optical disk but transmitting the first light beam and the third light beam.

20. An optical pickup adapted to operate for optical disks of a plurality of different types, the optical pickup comprising:
a light source for emitting a first light beam with a wavelength matching a first optical disk or a second light beam with a wavelength matching a second optical disk;
an objective lens for converging the first light beam or the second light beam emitted from the light source onto the recording surface of the first optical disk or the second optical disk, whichever appropriate; and
a first aberration correcting unit arranged on the light path of the first light beam between the light source and the objective lens to cancel the coma arising due to the objective lens.

21. An optical pickup adapted to operate for optical disks of a plurality of different types showing different thicknesses for the transparent substrate for receiving a light beam, the optical pickup comprising:
a light source for selectively emitting a first light beam with a wavelength matching a first optical disk or a second light beam with a wavelength matching a second optical disk;
an objective lens for converging the first light beam or the second light beam emitted from the light source onto the recording surface of the first optical disk or the second optical disk, whichever appropriate;
a first aberration correcting unit arranged on the light path of the first light beam between the light source and the objective lens to cancel the coma arising due to the objective lens; and
the first aberration correcting unit transforming the first light beam emitted from the light source from collimated light into a wave front having the profile of the first aberration correcting unit and containing a power component.

22. An optical disk apparatus equipped with an optical pickup adapted to operate for optical disks of a plurality of different types, the apparatus comprising:
a light source for emitting a first light beam with a wavelength matching a first optical disk or a second light beam with a wavelength matching a second optical disk;
an objective lens for converging the first light beam or the second light beam emitted from the light source onto the recording surface of the first optical disk or the second optical disk, whichever appropriate; and
a first aberration correcting unit arranged on the light path of the first light beam between the light source and the objective lens to cancel the coma arising due to the objective lens.
